(19) United States
(12) Patent Application Publication
(10) Pub. No.: US 2020/0346326 A1
(43) Pub. Date: Nov. 5, 2020

(54) HIGH STRUCTURAL STRENGTH SOCKET

(71) Applicant: Hong Ann Tool Industries Co., Ltd., Taichung City (TW)

(72) Inventor: Cheng-Wei SU, Taichung City (TW)

(21) Appl. No.: 16/788,555

(22) Filed: Feb. 12, 2020

(30) Foreign Application Priority Data
Apr. 30, 2019 (TW) 108115078

(51) Int. Cl. B25B 13/06

(52) U.S. Cl. CPC B25B 13/065

(57) ABSTRACT

A socket includes a main body with a connecting portion and a first joining portion. The connecting portion defines a space. The first joining portion extends circumferentially on an outer periphery of the main body and includes a plurality of recesses and a plurality of protrusions disposed circumferentially. The first joining portion surrounds the connecting portion. The socket includes a sleeve with a second joining portion. The second joining portion includes a plurality of recesses and a plurality of protrusions disposed circumferentially. The sleeve is retained on the main body and the second joining portion matches with the first joining portion, with the plurality of recesses of the first joining portion corresponding to the plurality of protrusions of the second joining portion and the plurality of protrusions of the first joining portion corresponding to the plurality of recesses of the second joining portion.

### BACKGROUND OF THE INVENTION

### 1. Field of the Invention

The present invention relates to a socket and, particularly, to a socket engineered to have high structural strength.

### 2. Description of the Related Art

TW Pat. No. 1618604 relates to a socket. The socket has a main body provided with a first fitting portion, a second fitting portion, a first peripheral surface, a third fitting portion, a second peripheral surface, an abutment edge, at least two annular grooves, and a first end portion. A print is provided on the first peripheral surface by a printing method, which makes the print and the first peripheral surface integrate with each other. The color of the print is different from the color of the main body. The print is provided with an indicia. The indicia indicates the specification and dimension of the third fitting portion. The indicia has a display state different from the print. A sleeve, which is transparent, or translucent or frosted, is fitted over the first peripheral surface and the print. The sleeve allows the first peripheral surface of the main body and the print to be seen. The sleeve includes a first end disposed on the abutment edge and a second end being flush with the first end portion. The inner periphery of the sleeve has at least two annular protrusions corresponding to the at least two annular grooves. When the at least two protrusions are received by the at least two annular grooves respectively, the sleeve is adapted to be retained on the main body.

When using the socket to drive an object, the object is disposed in the first, the second, and the third fitting portions. Further, the corner of a hexagonal hole defined by the third fitting portion often suffers stress concentration. Thus, the socket is liable to get damaged easily from the third fitting portion.

The present invention is, therefore, intended to obviate or at least alleviate the problems encountered in the prior art.

### SUMMARY OF THE INVENTION

According to the present invention, a socket includes a main body with a first connecting portion and a first joining portion. The first connecting portion extends circumferentially on an inner periphery of the main body and defines a space. The first connecting portion includes a plurality of surfaces disposed circumferentially and surrounding the space. The first joining portion extends circumferentially on an outer periphery of the main body and includes a plurality of recesses and a plurality of protrusions disposed circumferentially. The first joining portion surrounds the first connecting portion. The socket includes a sleeve with a second joining portion. The second joining portion extends circumferentially on an inner periphery of the sleeve and includes a plurality of recesses and a plurality of protrusions disposed circumferentially. The sleeve is retained on the main body and the second joining portion matches with the first joining portion, with the plurality of recesses of the first joining portion corresponding to the plurality of protrusions of the second joining portion and the plurality of protrusions of the first joining portion corresponding to the plurality of recesses of the second joining portion.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a socket in accordance with the present invention.

FIG. 2 is an exploded perspective view of the socket of FIG. 1.

FIG. 3 is a cross-sectional view of the socket of FIG. 1.

FIG. 4 is another cross-sectional view of the socket taken along line 4-4 of FIG. 3.

FIG. 5 is another cross-sectional view of the socket taken along line 5-5 of FIG. 3.

### DETAILED DESCRIPTION OF THE INVENTION

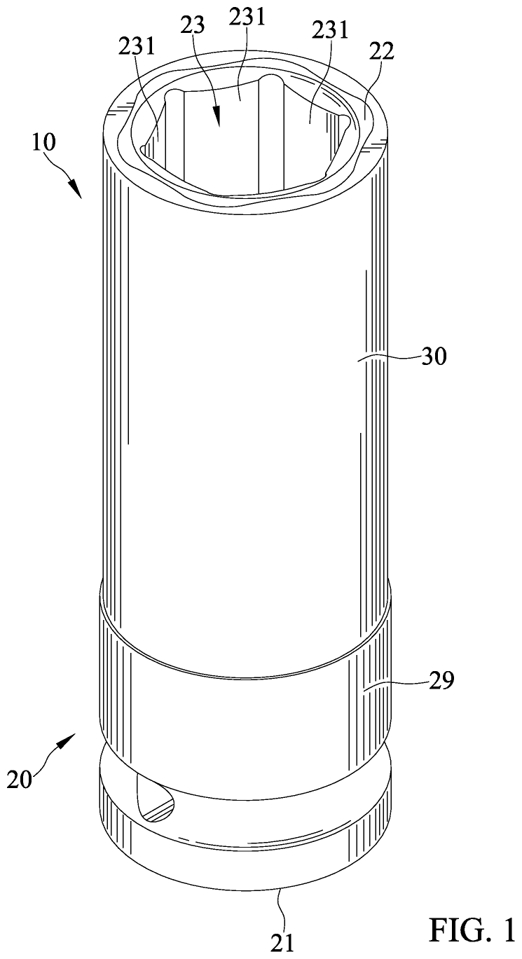

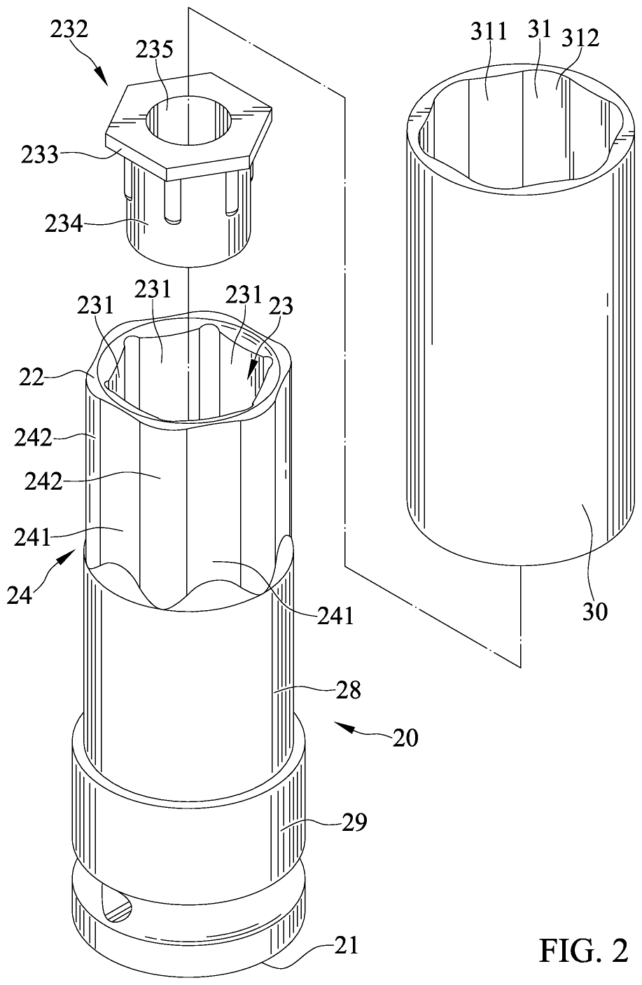

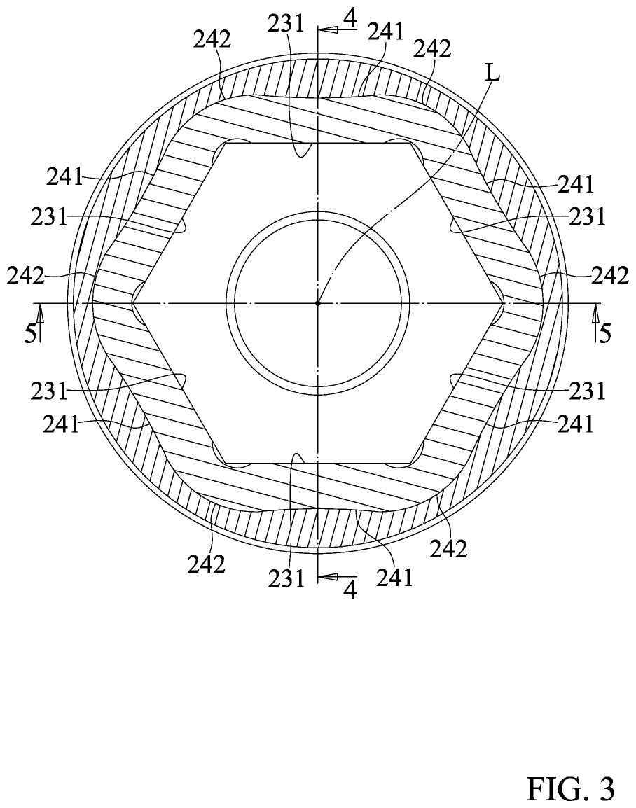

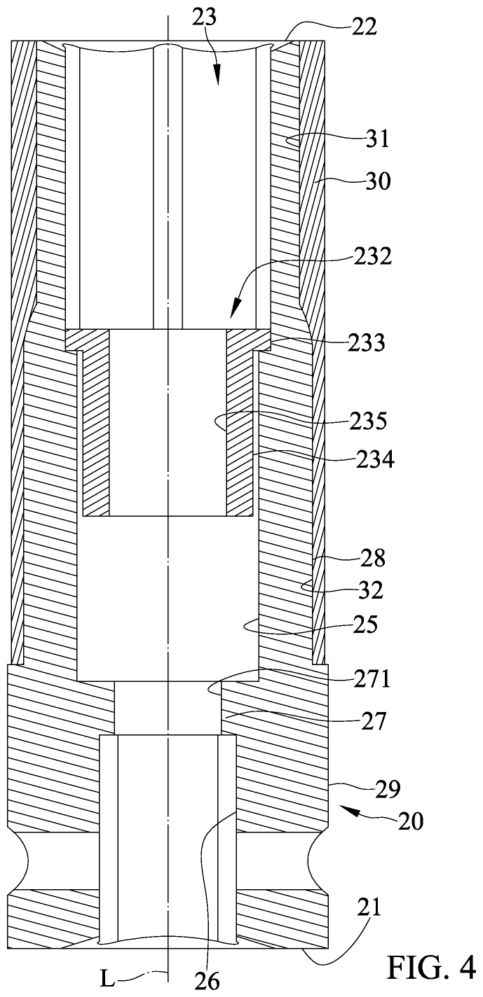

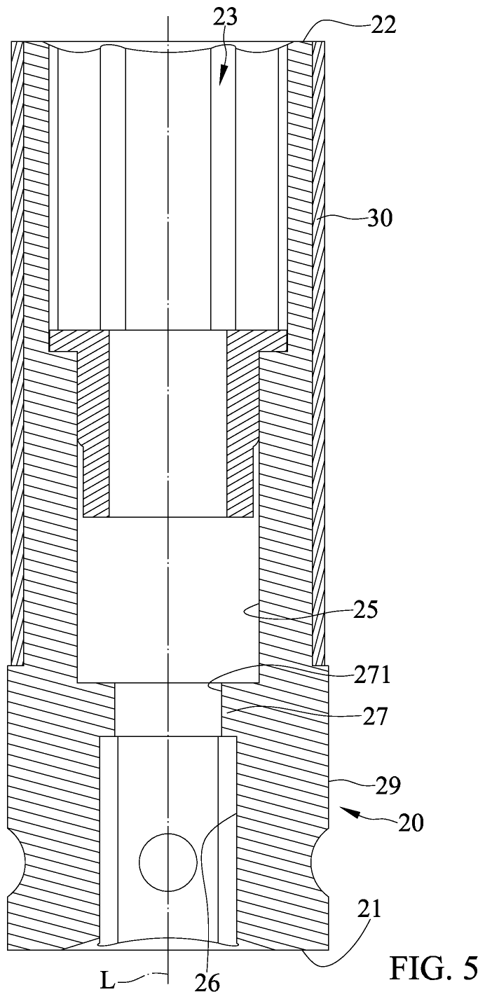

FIGS. 1 through 5 show a socket 10 in accordance with the present invention.

The socket 10 has a main body 20. The main body 20 has an end 21 and an end 22 and has a longitudinal length extending from the end 21 to the end 22 along a center line L of the socket 10. The center line L of the socket coincides with an axis of rotation of the socket 10.

The main body 20 has a connecting portion 23. The connecting portion 23 extends circumferentially on a first inner periphery of the main body 20 and defines a space. The space of the connecting portion 23 is configured to engage with an object to be driven by the socket 10, thereby allowing the object to be driven to couple to the socket 10. The connecting portion 23 includes a plurality of surfaces 231 disposed circumferentially and surrounding the space. The space of the connecting portion 23 is polygonal.

The main body 20 has a joining portion 24. The joining portion 24 extends circumferentially on a first outer periphery of the main body 20 and includes a plurality of recesses 241 and a plurality of protrusions 242 disposed circumferentially. Thus, the joining portion 24 has a varying radius. The joining portion 24 surrounds the connecting portion 23.

The main body 20 has a joining portion 28. The joining portion 28 extending circumferentially on a second outer periphery of the main body 20. The joining portion 28 is circular. The joining portion 24 has a maximum radius not greater than a radius of the third joining portion 28. The maximum radius of the joining portion 24 and the radius of the joining portion 28 are measured from the center line L of the socket 10. In the embodiment, the maximum radius of the joining portion 24 is equal to the radius of the third joining portion 28.

The main body 20 has a joining portion 29 extending circumferentially on a third outer periphery of the main body 20. The joining portion 29 has a maximum radius, which is measured from the center line L of the socket 10, greater than the radius of the joining portion 28.

The main body 20 has a second inner periphery and an interconnecting portion 25 extending circumferentially on the second inner periphery. The interconnecting portion 25 defines a space. The spaces of the interconnecting portion 25 and the connecting portion 23 are communicated with each other. The space of the interconnecting portion 25 is circular.

The main body 20 includes a stop 232 disposed in the connecting portion 23 and the interconnecting portion 25. The stop 232 is configured to abut against the object disposed in the connecting portion 23. The stop 232 has a section 233 of a first width disposed in the joining portion 24 and a section 234 of a second width, which is smaller than the first width, disposed in the interconnecting portion 25. The stop 232 defines a hole 235 extending therethrough. The hole 235 has an open end disposed in the connecting portion 23 an open end disposed in the interconnecting portion 25. The section 233 of the stop 232 is polygonal and includes peripheral sides corresponding to the plurality of surfaces 231 of the connecting portion 23. The section 234 of the stop 232 is circular.

The main body 20 has a third inner periphery and a connecting portion 26 extending circumferentially on the third inner periphery. The connecting portion 26 defines a space designed to engage with a driving device, thereby allowing the driving device to couple to the socket 10. The spaces of the connecting portion 26 and the interconnecting portion 25 are communicated with each other.

The main body 20 has a fourth inner periphery and an interconnecting portion 27 extending circumferentially on the fourth inner periphery. The second interconnecting portion 27 defines a hole 271. The hole 271 interconnects the spaces of the interconnecting portion 25 and the connecting portion 26.

The socket 10 has a sleeve 30. The sleeve 30 is made of plastic, but not limited thereto. The sleeve 30 can be opaque, or transparent or translucent. The sleeve 30 is retained on the main body 20.

The sleeve 30 has a joining portion 31. The joining portion 31 extends circumferentially on a first inner periphery of the sleeve 30 and includes a plurality of recesses 311 and a plurality of protrusions 312 disposed circumferentially. When the sleeve 30 is retained on the main body 20, the joining portion 31 matches with the joining portion 24, the plurality of recesses 241 of the joining portion 24 corresponding to the plurality of protrusions 312 of the joining portion 31, and the plurality of protrusions 242 of the joining portion 24 corresponding to the plurality of recesses 311 of the joining portion 31. Moreover, the sleeve 30 has a distal end supported by a surface extending radially between the joining portions 28 and 29.

The sleeve 30 has a second inner periphery and a joining portion 32 extending circumferentially on the second inner periphery. The joining portion 32 surrounds the joining portion 28.

In view of the foregoing, the socket 10 is not liable to get damaged because the joining portion 24 designed with the plurality of recesses 241 and the plurality of protrusions 242 effectively prevents against stress concentration. Further, the sleeve 30 is stably retained on the main body 20 because the joining portion 31 matches with the joining portion 24, with the plurality of recesses 241 of the joining portion 24 corresponding to the plurality of protrusions 312 of the joining portion 31 and the plurality of protrusions 242 of the joining portion 24 corresponding to the plurality of recesses 311 of the joining portion 31.

The foregoing is merely illustrative of the principles of this invention and various modifications can be made by those skilled in the art without departing from the scope and spirit of the invention.

What is claimed is:

1. A socket comprising:
a main body with a first connecting portion and a first joining portion, the first connecting portion extends circumferentially on a first inner periphery of the main body and defines a space, wherein the first connecting portion includes a plurality of surfaces disposed circumferentially and surrounding the space, wherein the first joining portion extends circumferentially on a first outer periphery of the main body and includes a plurality of recesses and a plurality of protrusions disposed circumferentially, and wherein the first joining portion surrounds the first connecting portion; and
a sleeve with a second joining portion, wherein the second joining portion extends circumferentially on a first inner periphery of the sleeve and includes a plurality of recesses and a plurality of protrusions disposed circumferentially, and wherein the sleeve is retained on the main body and the second joining portion matches with the first joining portion, with the plurality of recesses of the first joining portion corresponding to the plurality of protrusions of the second joining portion and the plurality of protrusions of the first joining portion corresponding to the plurality of recesses of the second joining portion.

2. The socket as claimed in claim 1, wherein the main body includes a third joining portion extending circumferentially on a second outer periphery of the main body, wherein the third joining portion is circular, wherein the first joining portion has a varying radius, wherein the first joining portion has a maximum radius not greater than a radius of the third joining portion, and wherein the maximum radius of the first joining portion and the radius of the third joining portion are measured from a center line of the socket.

3. The socket as claimed in claim 2, wherein the maximum radius of the first joining portion is equal to the radius of the third joining portion.

4. The socket as claimed in claim 2, wherein the main body has a fourth joining portion extending circumferentially on a third outer periphery of the main body, wherein the fourth joining portion has a maximum radius, which is measured from the center line of the socket, greater than the radius of the third joining portion, wherein the sleeve has a second inner periphery and a fifth joining portion extending circumferentially on the second inner periphery, wherein the fifth joining portion surrounds the third joining portion, and wherein the sleeve has a distal end supported by a surface extending radially between the third and the fourth joining portions.

5. The socket as claimed in claim 1, wherein the main body has a second inner periphery and a first interconnecting portion extending circumferentially on the second inner periphery, wherein the first interconnecting portion defines a space, wherein the spaces of the first interconnecting portion and the first connecting portion are communicated with each other, and wherein the main body includes a stop disposed in the first connecting portion and the first interconnecting portion.

6. The socket as claimed in claim 5, wherein the stop has a first section of a first width disposed in the first joining portion and a second section of a second width, which is smaller than the first width, disposed in the first interconnecting portion, wherein the stop defines a hole extending therethrough, and wherein the hole has a first open end disposed in the first connecting portion a second open end disposed in the first interconnecting portion.

7. The socket as claimed in claim 6, wherein the main body has a third inner periphery and a second connecting portion extending circumferentially on the third inner periphery, wherein the second connecting portion defines a space designed to engage with a driving device, thereby allowing the driving device to couple to the socket, and wherein the spaces of the second connecting portion and the first interconnecting portion are communicated with each other.

8. The socket as claimed in claim 6, wherein the space of the first interconnecting portion is circular, and wherein the space of the first connecting portion is polygonal.

9. The socket as claimed in claim 8, wherein the first section of the stop is polygonal and includes peripheral sides corresponding to the plurality of surfaces of the first connecting portion, and wherein the second section of the stop is circular.

10. The socket as claimed in claim 7, wherein the main body has a fourth inner periphery and a second interconnecting portion extending circumferentially on the fourth inner periphery, wherein the second interconnecting portion defines a hole, and wherein the hole interconnects the spaces of the first interconnecting portion and the second connecting portion.
